(19) United States
(12) Patent Application Publication
(10) Pub. No.: US 2008/0137515 A1
(43) Pub. Date: Jun. 12, 2008

(54) OPTICAL INFORMATION RECORDING/REPRODUCING APPARATUS AND OPTICAL INFORMATION RECORDING MEDIUM

(75) Inventor: Yasuaki Morimoto, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/020,114

(22) Filed: Jan. 25, 2008

Related U.S. Application Data
(63) Continuation of application No. PCT/JP2005/014229, filed on Aug. 3, 2005.

(51) Int. Cl. G11B 7/00

(52) U.S. Cl. 369/112.01

(57) ABSTRACT

When an optical information recording/reproducing apparatus receives a request for accessing to an optical information recording medium from a host computer, an optical pickup unit reads an access-restriction code that is recorded on a ROM data-layer of the optical information recording medium, a comparing unit compares the read access-restriction code with a key unique-code that is recorded on an IC card, and a controller determines whether accessing to the optical information recording medium is allowable based on a result of the comparison.

### BACKGROUND OF THE INVENTION

1. Field of the Invention

The present invention relates to an optical information recording/reproducing apparatus that records or reproduces information to or from an optical information recording medium by emitting a light beam to the optical information recording medium. More specifically, the present invention relates to an optical information recording/reproducing apparatus and an optical information recording medium that can prevent falsification of identification information for identifying a user but can receives a change of the identification information from an authorized user in an effective manner.

2. Description of the Related Art

Contents, for example, text data, still image data, video data, audio data, and program data can be recorded for sale on a removable medium such as a compact disk (including CD-R and CD-RW) or a DVD (including DVD±RW and DVD-RAM). To protect copyright of contents of movie, music, program, or the like that are recorded on such a removable medium, there proposed a technique of preventing rewriting or falsification despite intension of the recorder thereby preventing illegal copy by un-authorized third parties. Such a technique includes music CD-ROMs with copy protection.

There have been made active studies and developments for achieving high-density recording or high-speed access concerning removable media or drives (devices for recording information onto a removable medium and/or for reproducing information from the removable medium). Among the studies and developments, there has been disclosed a concurrent ROMRAM that includes a read-only ROM (Read Only Memory) unit and a write-once RAM (Random Access Memory) unit (see, for example, Japanese Patent Application Laid-open No. H6-202820) and a hybrid-type removable medium such as a partial ROM, and a drive that can accept those removable media.

There has been also disclosed a conventional technique for targeting the hybrid-type removable media represented by the above-described concurrent ROMRAM to prevent rewriting against recorder's intention or falsification thereby preventing illegal copy by un-authorized third parties.

Japanese Patent Application Laid-open No. H2003-36595 or No. H2003-115163, for example, discloses an optical disk that includes a ROM area on which information unique to the disk is recorded and a write-once RAM area. Contents are recorded on either the ROM area or the RAM area. If contents that are recorded on the optical disk according to each of the Japanese Patent Applications cited above are copied to another optical disk, because unique information of the copy-destination optical disk is different from that of the copy-source optical disk or no unique information is recorded on the ROM area of the copy-destination optical disk, it is impossible to use the contents recorded on the RAM area. This makes it possible to prevent rewriting against recorder's intention or falsification thereby preventing illegal copy by un-authorized third parties. An optical disk according to Japanese Patent Application Laid-open No. H2003-115163 records a security signature containing a user secret key on the RAM area. To write new contents onto the RAM area, a public-key based authentication and encryption is performed via a network.

### SUMMARY OF THE INVENTION

It is an object of the present invention to at least partially solve the problems in the conventional technology.

According to an aspect of the present invention, an optical information recording/reproducing apparatus is for recording or reproducing information on or from an optical information recording medium by emitting a light beam to the optical information recording medium, the optical information recording medium including a first recording layer on which information is recorded and a second recording layer on which information corresponding to the information recorded on the first recording layer is recorded. The optical information recording/reproducing apparatus includes an acquiring unit that acquires the information recorded by using interference of light beams on the first recording layer and the information recorded on the second recording layer corresponding to the information recorded on the first recording layer at one time.

According to another aspect of the present invention, an optical information recording medium includes a first recording layer on which information is recorded by using interference of light beams; and a second recording layer on which information corresponding to the information recorded on the first recording layer is recorded, wherein the information recorded on the second recording layer is to be accessed together with the information recorded on the first recording layer, and the second recording layer is spaced apart from the first recording layer in a predetermined distance.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a diagram of a spatial light modulation element that is provided with an optical information recording device for generating a record light and a reference light;

FIG. 2 is a diagram for explaining a modulated state of a light beam passing through a plurality of segments of the spatial light modulation element shown in FIG. 1;

FIG. 3 is a diagram for explaining a principle of an optical information recording process according to the present invention;

FIG. 4 is a diagram for explaining the structure of the spatial light modulation element shown in FIG. 1;

FIG. 5 is a diagram for explaining the structure of an optical-phase correction element;

FIG. 6A is a diagram of a state of liquid crystal molecules at the time when the optical-phase correction element is in an OFF state;

FIG. 6B is a diagram of a state of the liquid crystal molecules at the time when the optical-phase correction element is in an ON state;

FIG. 7 is a graph of a relation between an applied voltage applied to a spatial-light-intensity modulation element and the transmittance of a light beam;

FIG. 8 is a functional block diagram for explaining structure of an optical information recording/reproducing apparatus according to the present embodiment;

FIG. 9 is an exemplary functional block diagram for explaining structure of an optical pickup unit;

FIG. 10 is a diagram for explaining structure of a conjugate focus conversion lens 44 shown in FIG. 9;

FIG. 11 is a diagram for explaining structure of an optical information recording medium according to the present embodiment (in which address information and access-restriction code are recorded as non-rewritable optical-phase pits);

FIG. 12 is a diagram for explaining structure of the optical information recording medium according to the present embodiment (of which the access-restriction code is recorded on a rewritable area);

FIG. 13 is an explanatory diagram (1) for explaining a relation between a light beam and units that form the optical information recording medium;

FIG. 14 is an explanatory diagram (2) for explaining a relation between the light beam and the units that form the optical information recording medium;

FIG. 15 is an exemplary diagram of an IC card shown in FIG. 8;

FIG. 16A is an explanatory diagram (1) for explaining a relation between the access-restriction code recorded on a ROM data-layer and user data recorded on a RAM data-layer;

FIG. 16B is an explanatory diagram (2) for explaining a relation between the access-restriction code recorded on a ROM data-layer and user data recorded on a RAM data-layer;

FIG. 16C is an explanatory diagram (3) for explaining a relation between the access-restriction code recorded on a ROM data-layer and user data recorded on a RAM data-layer;

FIG. 17 is an explanatory diagram for explaining correspondence relation between a plurality of ROM data-layers and RAM data-layers in which the ROM data-layers lie in the depth direction of the optical information recording medium; and

FIGS. 18A and 18B are diagrams for explaining the structure of a card-type optical information recording medium.

### DETAILED DESCRIPTION OF THE PREFERRED EMBODIMENTS

An optical information recording/reproducing apparatus and an optical information recording medium according to exemplary embodiments of the present invention are described in detail below with reference to the accompanying drawings. The present invention is not limited to these exemplary embodiments.

Features of the optical information recording/reproducing apparatus and the optical information recording medium according to the present embodiment are described. The optical information recording medium according to the present embodiment includes a ROM area formed with a ROM (Read Only Memory) data-layer and a RAM area formed with a RAM (Random Access Memory) data-layer. The ROM area stores access-restriction codes for restricting reading and/or writing information. When the optical information recording/reproducing apparatus read or write information from or to the RAM area, reading or writing information is restricted based on an access-restriction code in the ROM area corresponding to the information, and a host computer is notified of only presence of the RAM data-layer.

The ROM data-layer includes a rewritable or writable area (hereinafter, abbreviated to “rewritable area”). Before writing information onto the rewritable area, the optical information recording/reproducing apparatus compares a key unique-code of an IC (integrated Circuit) card that belongs to an administrator or the like with an access-restriction code recorded on the ROM data-layer thereby restricting writing of information on the rewritable area of the ROM data-layer.

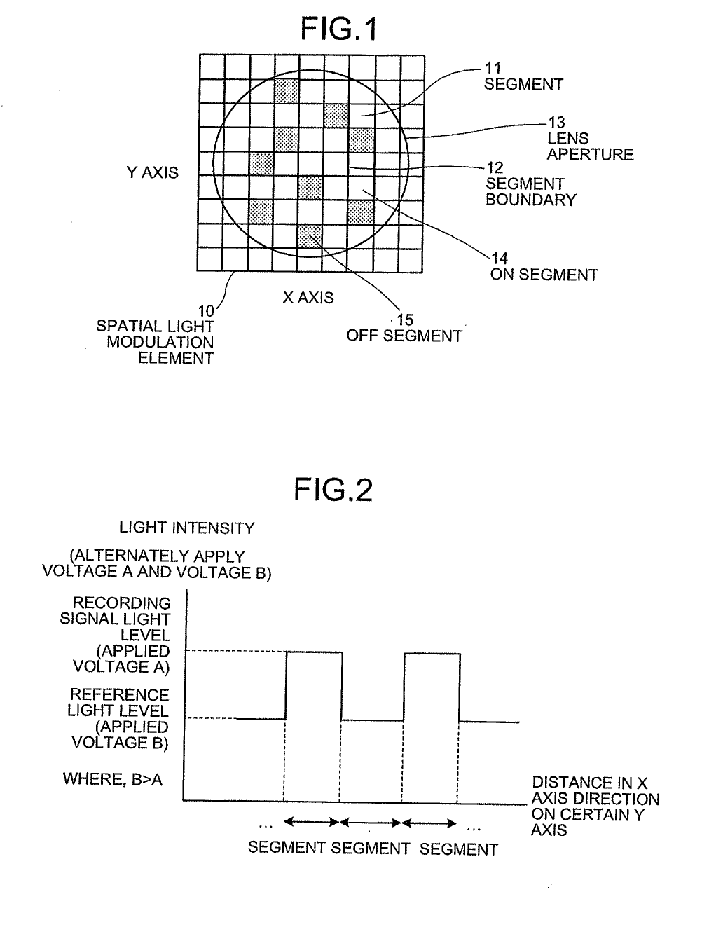

Given below is an explanation of a spatial light modulation element according to the present embodiment. FIG. 1 is a diagram for explaining a spatial light modulation element 10 provided in the optical information recording and reproducing apparatus that generates recording signal light and reference light. As shown in FIG. 1, the spatial light modulation element 10 has segments 11 and segment boundaries 12. As shown in FIG. 1, a relation between the spatial light modulation element 10 and a lens aperture 13 of a collimator lens that causes a light beam to converge on the spatial light modulation element 10 is shown.

The respective segments 11 are separated by the segment boundaries 12. The spatial light modulation element 10 is formed of a liquid crystal element or an electric optical element, refractive index anisotropy of which electrically changes. Thus, when a voltage is applied to the respective segments 11, the respective segments 11 change to ON segments 14 in which the intensity of transmitted light or reflected light is high or OFF segments 15 in which the intensity of transmitted light or reflected light is low (not 0).

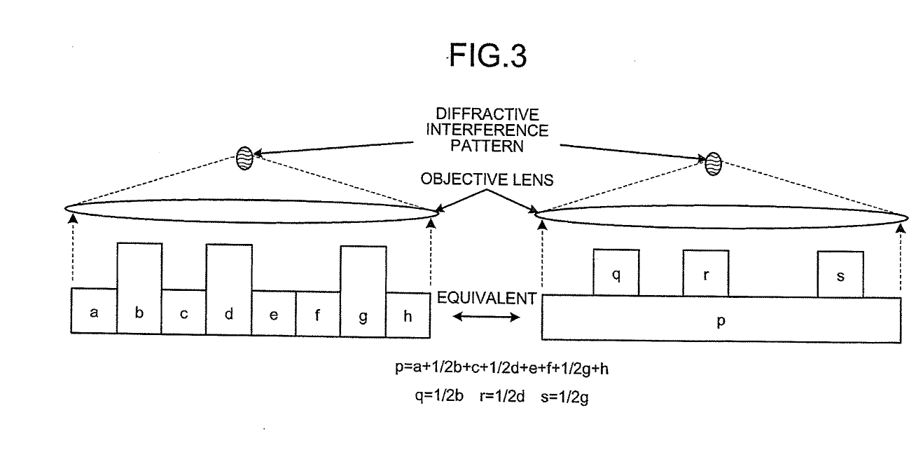

FIG. 2 is a diagram of a modulation state of the light intensity of a light beam transmitted through a plurality of respective segments 11 of the spatial light modulation element 10 shown in FIG. 1. As shown in the figure, an applied voltage for generating recording signal light is set as A, an applied voltage for generating reference light is set as B (B>A), and the applied voltages A and B are alternately applied to the respective segments 11. According to the present embodiment, recording signal light and reference light are generated in a superimposed state by transmitting a laser beam as a light source through the spatial light modulation element 10. The recording signal light and the reference light are emitted to the optical information recording medium and form an interference pattern in a recording layer of the optical information recording medium thereby recording light information.

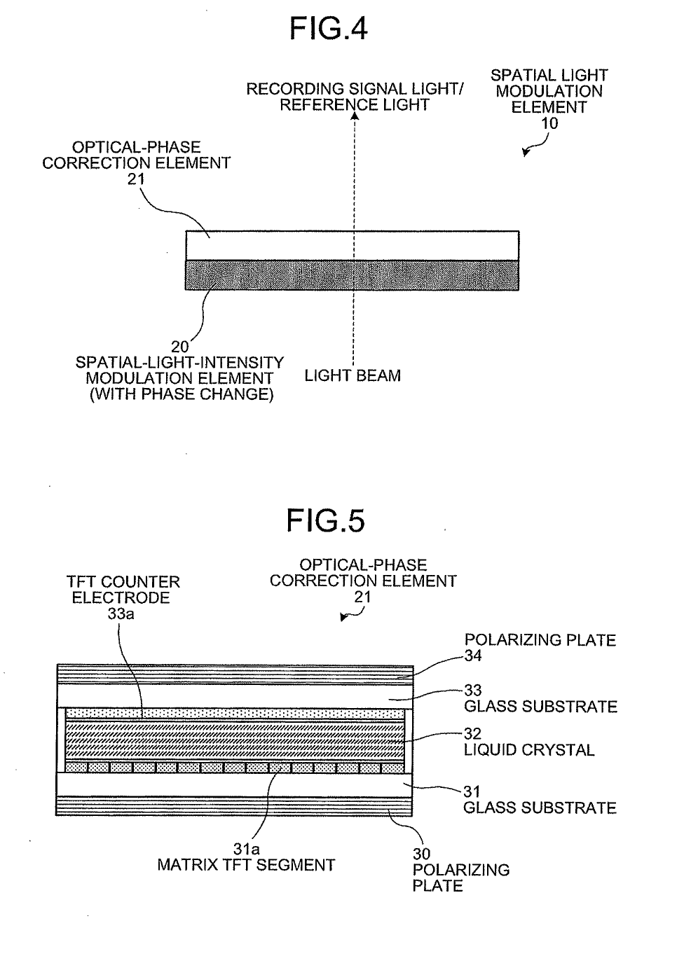

FIG. 3 is a diagram for explaining a principle of optical information recording processing according to the present invention. According to a principle explained below, a light beam generated using the spatial light modulation element 10 is reference light over the entire surface of the light beam and changes to recording signal light that can be subjected to light intensity modulation according to recording information over the entire surface. In the recording layer of the optical information recording medium, the light beam is diffracted and interferes near a focus of an objective lens that converges the light beam and a diffractive interference pattern in which the reference light and the recording signal light are three-dimensionally diffracted and interfere with each other is recorded.

FIG. 3 indicates that an interference pattern generated by a light beam (light intensity components a, b, c, d, e, f, g, and h) transmitted through the respective segments 11 is equivalent to a diffractive interference pattern generated from reference light (a light intensity component p) and recording signal light (light intensity components q, r, and s).

In general, strong far-field diffraction occurs in a three-dimensional area near a focus including a focal plane of an objective lens. According to the Babinet's principle, light intensity components of the respective segments 11 of the spatial light modulation element 10 independently subjected to Fourier transform in integration areas of the respective light intensity components and added up are equivalent to light intensity components of all the respective segments 11 subjected to Fourier transform in all the integration areas. Based on this equality of the light intensity components and linearity in Fourier transform, a diffractive interference pattern in the example in FIG. 3 can be represented as follows:

A diffractive interference pattern

$$\begin{matrix}= F ( a ) + F ( b ) + F ( c ) + F ( d ) + F ( e ) + F ( f ) + F ( g ) + F ( h ) \\ = F ( a ) + F ( 2 q ) + F ( c ) + F ( 2 r ) + F ( e ) + F ( f ) + F ( 2 s ) + F ( h ) \\ = F ( a ) + 2 F ( q ) + F ( c ) + 2 F ( r ) + F ( e ) + F ( f ) + 2 F ( s ) + F ( h ) \\ = F ( a ) + F ( 1 / 2 b ) + F ( q ) + F ( c ) + F ( 1 / 2 d ) + F ( r ) + F ( e ) + \\ F ( f ) + F ( 1 / 2 g ) + F ( s ) + F ( h ) \\ = F ( a ) + F ( 1 / 2 b ) + F ( c ) + F ( 1 / 2 d ) + F ( e ) + \\ F ( f ) + F ( 1 / 2 g ) + F ( h ) + F ( q ) + F ( f ) + F ( s )\end{matrix}$$

Here, F(x) indicates Fourier transform of a light intensity component x. For simplicity of explanation,

q=1/2 b,

r=1/2 d, and

s=1/2 g.

When p=a+1/2 b+c+1/2 d+e+f+1/2 g+h, according to the Babinet's principle and the linearity of Fourier transform, F(a)+F(1/2 b)+F(c)+F(1/2 d)+F(e)+F(f)+F(1/2 g)+F(h)=F(p). Thus,

a diffractive interference pattern

$$\begin{matrix}= F ( p ) + ( F ( g ) + F ( r ) + F ( s ) ) \\ = F ( p ) + F ( q + r + s ) .\end{matrix}$$

Because the same diffraction phenomenon appears even when the reference light and the recording signal light are separated in this way, a strong diffractive interference pattern due to the reference light and the recording signal light appears in a three-dimensional space near the focus including the focal plane.

On the other hand, in a section considerably apart from the focus, because a diffraction effect is small and a light density is also small, the intensity of a diffractive interference pattern is extremely weak. The diffractive interference pattern is recorded only near a convergent point according to a relation between the intensity and the sensitivity of a recording material.

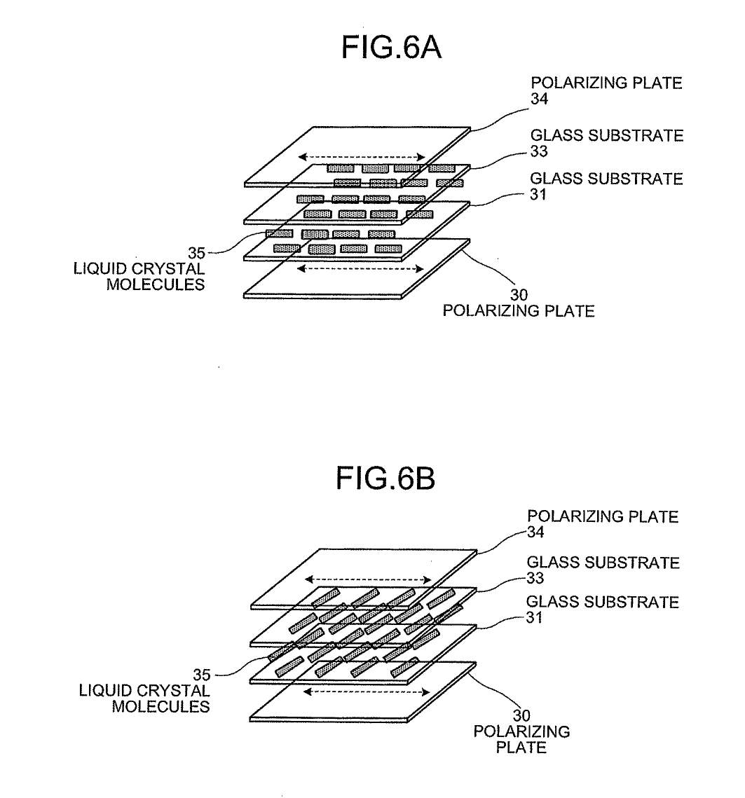

Given below is an explanation of the spatial light modulation element 10 shown in FIG. 1. FIG. 4 is a diagram for explaining the structure of the spatial light modulation element 10 shown in FIG. 1. As shown in FIG. 4, recording signal light and reference light are generated by causing a light beam to pass through a spatial-light-intensity modulation element 20 and an optical-phase correction element 21 stuck together.

The spatial-light-intensity modulation element 20 includes a liquid crystal element of a TN (Twisted Nematic) type. The optical-phase correction element 21 includes a liquid crystal element of a TFT (Thin Film Transistor) type. In this embodiment, the spatial-light-intensity modulation element 20 and the optical-phase correction element 21 include liquid crystal elements. However, an idea same as that in this embodiment can be applied when electric optical elements are used.

Each of the spatial-light-intensity modulation element 20 and the optical-phase correction element 21 are divided into the respective segments 11 by the segment boundaries 12 as shown in FIG. 1. The respective segments 11 of the spatial-light-intensity modulation element 20 and the optical-phase correction element 21 are arranged to share an area through which a light beam is transmitted.

The spatial-light-intensity modulation element 20 is an element that modulates the light intensity of a light beam transmitted therethrough. No problem occurs when the spatial-light-intensity modulation element 20 modulates only the light intensity of the light beam. However, in the case of an optical element such as a liquid crystal element that uses anisotropy of a refractive index of a substance, an optical phase always shifts.

When transmission light intensity of the respective segments 11 is changed according to recording information, the optical phase also changes. Thus, an optical phase of the reference light always changes according to a combination of ON and OFF of the segments. As a result, the reference light does not function as the reference light.

Naturally, when segments that generate recording signal light and segments that generate reference light are completely set independent from each other by arranging the former segments in the center of a spatial-light-intensity modulation element and arranging the latter segments around the former segments, no problem occurs even if an optical phase changes when light intensity is modulated. However, because a segment area that generates the recording signal light is reduced, an information recording density falls.

Therefore, the change in the optical phase caused by the transmission of the light beam through the spatial-light-intensity modulation element 20 is corrected using the optical-phase correction element 21. Specifically, the optical phase changes according a voltage applied to the spatial-light-intensity modulation element 20. Thus, for example, when laser power of a laser with which the spatial-light-intensity modulation element 20 is irradiated during information recording is changed, the optical-phase correction element 21 corrects the optical phase according to an optical phase characteristic of the spatial-light-intensity modulation element 20.

The correction of the optical phase can be easily performed by checking optical phase characteristics of the spatial-light-intensity modulation element 20 and the optical-phase correction element 21 with respect to an applied voltage in advance before building the elements in the optical information recording and reproducing apparatus, recording information concerning the optical phase characteristics in a memory provided in the optical information recording and reproducing apparatus, and reading out and using the information.

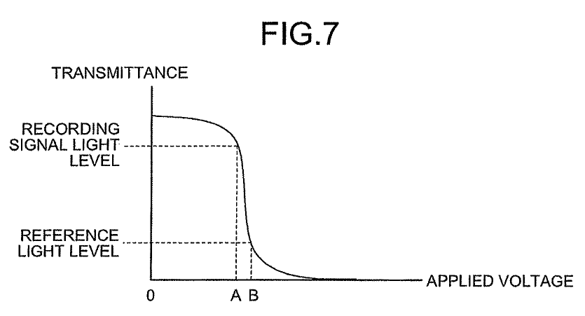

The structure of the optical-phase correction element 21 is explained. Because a general liquid crystal element of the TN type is used as the spatial-light-intensity modulation element 20, detailed explanation of the structure is omitted. FIG. 5 is a diagram for explaining the structure of the optical-phase correction element 21.

As shown in FIG. 5, the optical-phase correction element 21 has a polarizing plate 30, a glass substrate 31, liquid crystal 32, a glass substrate 33, and a polarizing plate 34. A polarization state of a light beam transmitted through the liquid crystal element of the TN type as the spatial-light-intensity modulation element 20 is linear polarized light. A transmission axis of the light beam through the polarizing plate 30 stuck to the glass substrate 31 coincides with a polarization direction of the linear polarized light.

A matrix TFT segment 31a, which is a TFT-driven segment of a matrix shape, is formed on the glass substrate 31. The polarizing plate 34 is stuck to the glass substrate 33. A direction of a transmission axis of the light beam through the polarizing plate 34 coincides with a direction of the transmission axis of the light beam through the polarizing plate 30.

A TFT counter electrode 33a, which is a counter electrode of the matrix TFT segment 31a formed on the glass substrate 31, is formed on the glass substrate 33. Orientation film treatment performed by rubbing an orientation agent such as polyimide is applied to inner side surfaces of the glass substrate 31 and the glass substrate 33. Liquid crystal molecules are oriented to coincide with the transmission axes of the light beam through the polarizing plate 30 and the polarizing plate 34.

By TFT-driving the liquid crystal molecules by segment units in a matrix shape using the optical-phase correction element 21 having such a structure, the tilt of the liquid crystal molecules can be controlled in a state in which directions of the liquid crystal molecules are aligned in one direction. According to a relation between the refractive index anisotropy and the optical phase, the optical phase of the light beam transmitted through the optical-phase correction element 21 can be freely adjusted. It is possible to correct the shift of the optical phase caused when the spatial-light-intensity modulation element 20 modulates the light intensity of the light beam.

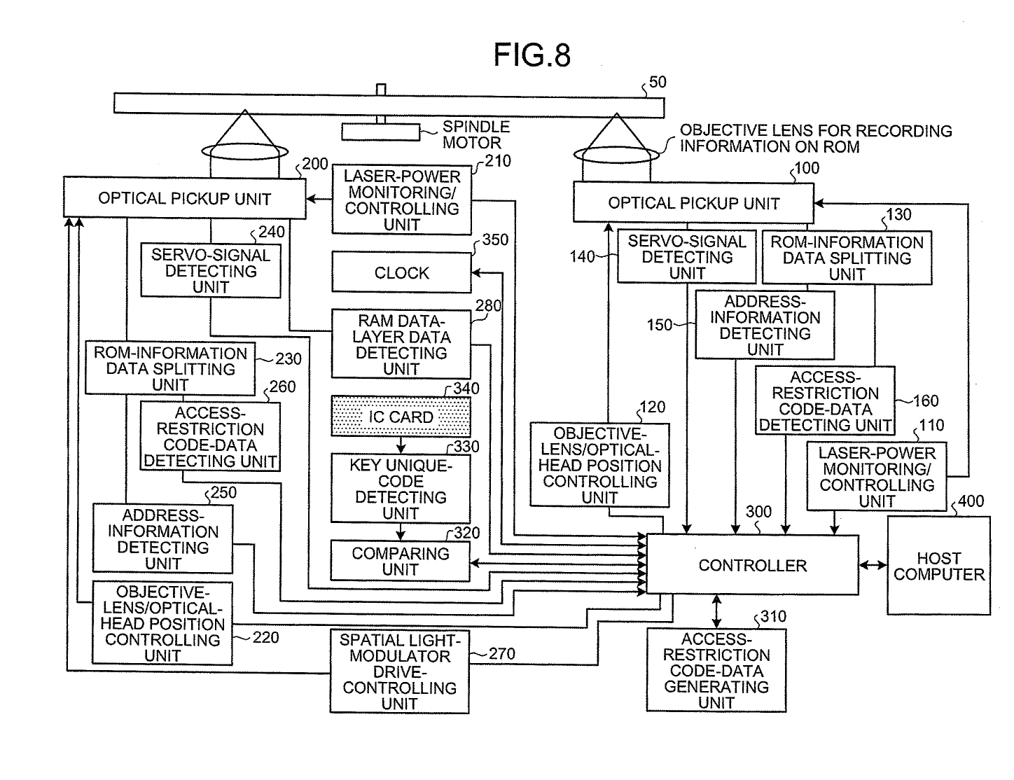

FIG. 6A is a diagram of a state of the liquid crystal molecules at the time when the optical-phase correction element 21 is in an OFF state. FIG. 6B is a diagram of a state of the liquid crystal molecules at the time when the optical-phase correction element 21 is in an ON state.

As shown in FIG. 6A, when the optical-phase correction element 21 is in the OFF state, i.e., a voltage is not applied to the segments of the optical-phase correction element 21, liquid crystal molecules are oriented in a direction determined by the rubbing treatment and the orientation film treatment.

As shown in FIG. 6B, when the optical-phase correction element 21 is in the ON state, i.e., a voltage is applied to the segments of the optical-phase correction element 21, the orientation direction of liquid crystal molecules 35 changes. The refractive index anisotropy thereof changes according to the change in the orientation direction. The shift of the optical phase of the light beam can be corrected by changing the refractive index anisotropy in this way.

The respective segments of the spatial-light-intensity modulation element 20 and the respective segments of the optical-phase correction element 21 are arranged vertically to be associated with each other in a one to one relation. To perform light intensity modulation according to recording information, in synchronization with the respective segments of the spatial-light-intensity modulation element 20 being brought in to the ON or OFF state, the segments of the optical-phase correction element 21 corresponding to the respective segments of the spatial-light-intensity modulation element 20 are brought into the ON or OFF state. The optical phase of the light beam transmitted through the optical-phase correction element 21 is controlled to be fixed over the entire surface of thereof.

As a specific method of correcting an optical phase, for example, there are a method of driving only the segments of the optical-phase correction element 21 corresponding to the segments of the spatial-light-intensity modulation element 20 brought into the ON state and matching an optical phase of recording signal light to an optical phase of reference light and a method of setting an optical phase at a maximum or minimum transmittance level of the spatial-light-intensity modulation element 20 as a reference and matching optical phases of recording signal light and reference signal light to the optical phase.

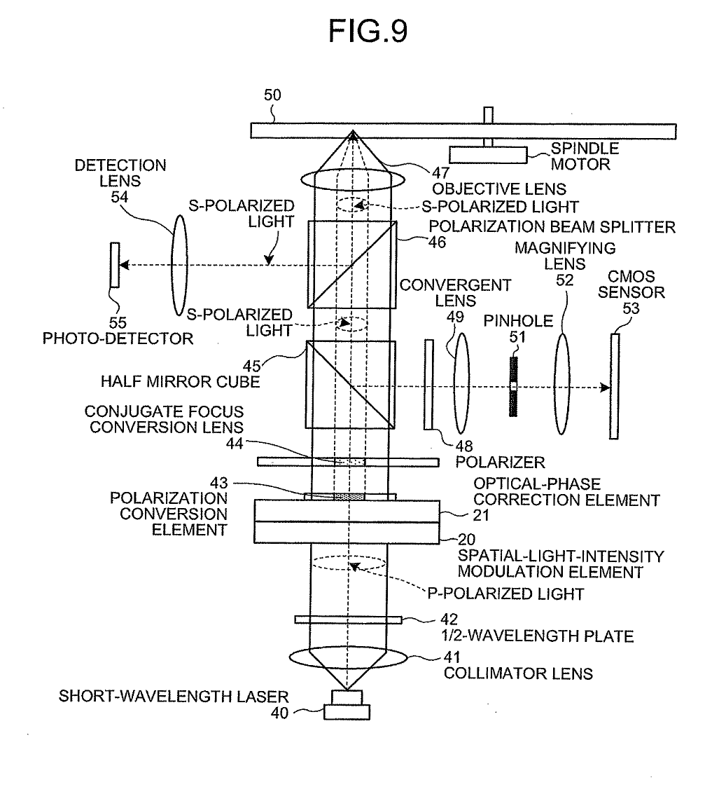

A relation between an applied voltage applied to the spatial-light-intensity modulation element 20 and the transmittance of a light beam is explained. FIG. 7 is a graph of a relation between an applied voltage applied to the spatial-light-intensity modulation element 20 and the transmittance of a light beam.

Because recording signal light has light intensity larger than that of reference light, as shown in FIG. 7, the voltage A smaller than the voltage B applied to the segments that generate reference light is applied to the segments that generate recording signal light such that the transmittance of a light beam through the segments that generate recording signal light is larger than the transmittance of a light beam through the segments that generate reference light.

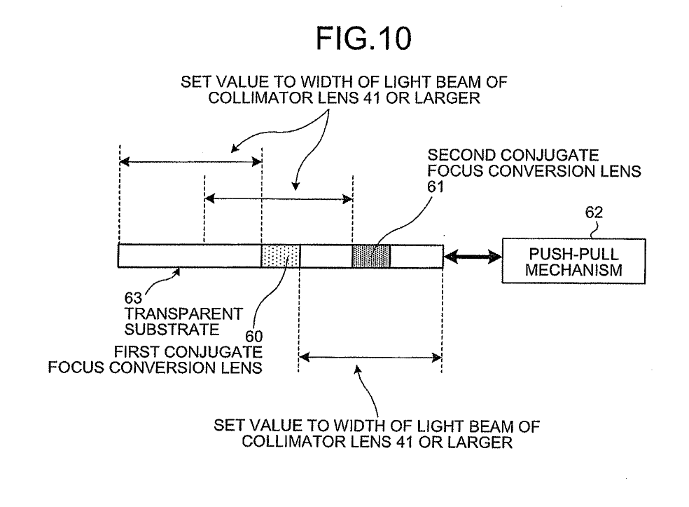

Given below is an explanation of structure of an optical information recording/reproducing apparatus according to the present embodiment. FIG. 8 is a functional block diagram for explaining structure of the optical information recording/reproducing apparatus according to the present embodiment. As shown in the figure, the optical information recording/reproducing apparatus includes optical pickup units 100 and 200, laser-power monitoring/controlling units 110 and 210, objective-lens/optical-head position controlling units 120 and 220, ROM-information data splitting units 130 and 230, servo-signal detecting units 140 and 240, address-information detecting units 150 and 250, access-restriction code-data detecting units 160 and 260, a spatial light-modulator drive-controlling unit 270, a RAM data-layer data detecting unit 280, a controller 300, an access-restriction code-data generating unit 310, a comparing unit 320, a key unique-code detecting unit 330, and a clock 350.

A user identifier 1, which is one of the access-restriction codes, is recorded on a ROM data-layer of an optical information recording medium 50 in a form of optical-phase pits, and the optical information recording medium 50 is inserted into the optical information recording/reproducing apparatus. To access the ROM data-layer of the optical information recording medium 50 by operation of an administrator using the optical information recording/reproducing apparatus, the administrator connects an IC card 340 to the key unique-code detecting unit 330. The key unique-code detecting unit 330 sends a key unique-code of the IC card 340 to the comparing unit 320. The access-restriction code is information for restricting access to data recorded on the ROM data-layer or the RAM data-layer.

The comparing unit 320 compares the key unique-code of the IC card 340 with the user identifier 1 recorded on the ROM data-layer. When the comparing unit 320 determines that the key unique-code is valid (determines that the administrator has authority for access to the ROM data-layer), the administrator can access to the ROM data-layer.

According to the present embodiment, the user identifier 1 that is formed with optical-phase pits is recorded on a lead-in area that is a ROM data-layer of the optical information recording medium 50. When the optical information recording medium 50 is inserted into the optical information recording/reproducing apparatus, the optical information recording/reproducing apparatus reads the user identifier 1 and compares the key unique-code of the IC card 340 with the user identifier. It is allowable to compare each user identifier 1 corresponding to each address with the key unique-code of the IC card 340 based on its address.

The comparing unit 320 compares the user identifier with the key unique-code. The user identifier 1 that is recorded on the ROM data-layer as optical-phase pits contains an identifier that has authority for permitting recording of the access-restriction code on a rewritable area.

When it is found from comparison result by the comparing unit 320 that there is such a code in the key unique-code of the IC card 340 that equivalent to the authority for permitting recording of the access-restriction code, the administrator can perform control/signal processing with the optical pickup unit 100 by inputting a predetermined record command into a host computer 400.

When it is determined from comparison result by the comparing unit 320 that the authority for permitting recording of the access-restriction code is not attached to the key unique-code, the controller 300 sends a signal for notifying presence of a RAM area that is the RAM data-layer formed with recording layers of the optical information recording medium 50 to the host computer 400. A recording command of recording data on the ROM data-layer is not valid. A case of having the authority for permitting recording of the access-restriction is explained below.

The controller 300 acquires a new access-restriction code and new digital data from the host computer 400, and recording or reproducing data on or from the optical information recording medium 50. The controller 300 sends data concerning the access-restriction code out of data acquired from the host computer 400 to the access-restriction code-data generating unit 310. The access-restriction code-data generating unit 310 converts data concerning the access-restriction code into a predetermined record format.

In a case the controller 300 accesses to the ROM data-layer of the optical information recording medium 50, the controller 300 sends a command to the objective-lens/optical-head position controlling unit 120. The objective-lens/optical-head position controlling unit 120 operates the optical pickup unit 100 and the objective lens thereof following the command so that the controller 300 accesses to a target address on the ROM data-layer.

In the process, the objective-lens/optical-head position controlling unit 120 controls a focus position and a track position, and the optical pickup unit 100 sends the address information and information on the access-restriction code to the ROM-information data splitting unit 130.

The ROM-information data splitting unit 130 splits data into the address information and the information on the access-restriction data, and sends the address information to the address-information detecting unit 150 and the information on the access-restriction data to the access-restriction code-data detecting unit 160. The access-restriction code-data detecting unit 160 detects the access-restriction code from the information on the access-restriction code, and sends the detected access-restriction code to the controller 300.

The address-information detecting unit 150 detects an address on which the laser beam has reached based on the address information, and sends the detected address to the controller 300. The controller 300 determines whether the address detected by the address-information detecting unit 150 is correct, that is, whether the light beam that emits from the optical pickup unit 100 converges on a proper position on the optical information recording medium 50. When the address is not correct, the controller 300 sends a command to the objective-lens/optical-head position controlling unit 120 to correct a position of the objective lens.

The laser-power monitoring/controlling unit 110 monitors a laser power of a long-wavelength laser emitting from the optical pickup unit 100, and supplies to the optical pickup unit 100 a predetermined laser power depending on the timing of accessing, reproducing, and recording.

When the access-restriction code that is recorded on the ROM data-layer is referred, the access-restriction code-data generating unit 310 generates various restriction-codes and the generated various restriction-codes are displayed on a display of the host computer 400 via the controller 300.

Subsequently, a recording process of recording data on a rewritable area of the ROM data-layer of the optical information recording medium 50 is explained. In a case the optical information recording/reproducing apparatus records data including the access-restriction code on a rewritable area of the ROM data-layer, the controller 300 acquires a new access-restriction code that has been converted into a predetermined record format from the access-restriction code-data generating unit 310.

The controller 300 sends the access-restriction code to the laser-power monitoring/controlling unit 110. The controller 300 simultaneously sends a command to the objective-lens/optical-head position controlling unit 120 so that the light beam converges on a target position on the optical information recording medium. The laser-power monitoring/controlling unit 110 generates a recording pulse following to the record format of the access-restriction code so that the access-restriction code is sequentially recorded on a specified position of the rewritable area.

The controller 300 acquires reproduction data that is detected by the access-restriction code-data detecting unit 160 to determine whether data recorded on the rewritable area is correct, and determines it by using an error detecting/correcting function that is one of functions of the controller 300. Specifically, the controller 300 performs a verifying process for determining whether quality of the reproduction data detected by the access-restriction code-data detecting unit 160 is acceptable. When the quality is not acceptable, the access-restriction code is recorded again on the same address rewritable area or on another address rewritable area.

In the above explanation according to the present embodiment, a new access-restriction code is recorded on a rewritable area of the ROM data-layer. If an encoder and a decoder are provided, it is possible to have a required function for dealing with music or movie digital data.

Subsequently, functions of the optical pickup unit 200 shown in FIG. 8 and its operation and signal processing are explained. Assuming that the comparison of the key unique-code of the IC card 340 with the user identifier 1 recorded on the ROM data-layer has finished in the following explanation of the optical pickup unit 200 below.

In a case the optical information recording/reproducing apparatus accesses to a recording layer that is the RAM data-layer of the optical information recording medium 50 to record data, the controller 300 acquires recorded data (data such as movie, image, or music data), and manages recording of data on the optical information recording medium 50. If there is data to be conversed among acquired various data, data conversion is performed by a cording unit of a not-shown dedicated hardware or software application.

To access to the ROM data-layer storing target recording-control information, which is recorded on the recording layer, to be recorded or reproduced, the controller 300 sends a command to the objective-lens/optical-head position controlling unit 220 to operate the optical pickup unit 200 and its objective lens so that the controller 300 accesses to an address on the ROM data-layer. In the process, the objective-lens/optical-head position controlling unit 220 controls a focus position and a track position.

The ROM-information data splitting unit 230 acquires address information and information on the access-restriction code from the optical pickup unit 200, and splits the data into the address information and the information on the access-restriction data. The ROM-information data splitting unit 230 sends the address information to the address-information detecting unit 250 and the information on the access-restriction data to the access-restriction code-data detecting unit 260.

The address-information detecting unit 250 detects an address on which the laser beam has reached based on the address information, and sends the detected address to the controller 300. The controller 300 determines whether the address detected by the address-information detecting unit 250 is correct, that is, whether the light beam that emits from the optical pickup unit 200 converges on a proper position. When the address is not correct, the controller 300 sends a command to the objective-lens/optical-head position controlling unit 220 to correct a position of the objective lens.

The laser-power monitoring/controlling unit 210 monitors a laser power of the laser emitting from the optical pickup unit 200, and supplies to the optical pickup unit 200 a predetermined laser power depending on the timing of accessing, reproducing, and recording.

Subsequently, a recording process performed by the optical information recording/reproducing apparatus of recording data on the RAM data-layer is explained. The controller 300 acquires from the host computer 400 data to be recorded on the RAM data-layer. The controller 300 has a cording function of converting data acquired from the host computer 400 into page data to be recorded on the RAM data-layer.

The controller starts coding data on each page following a command from the host computer 400. Coded page data is sent to the spatial light-modulator drive-controlling unit 270.

The objective-lens/optical-head position controlling unit 220 controls the optical pickup unit 200 and its objective lens following the address that is detected by the address-information detecting unit 250 thereby it is shifted from a recording waiting state to a recording starting state.

The laser-power monitoring/controlling unit 210 increases the laser power at the optical pickup unit 200 to the recording level as a pulse output. The spatial light-modulator drive-controlling unit 270 changes, at the timing of the laser power increase, the light transmittance of each segment of the spatial light modulation element, and generates a reference light and a recording signal light with which information corresponding to the page data can be recorded on the recording layer.

When the laser-power monitoring/controlling unit 210 increases the laser power, a power level of the S-polarized server control beam also increases simultaneously. The optical pickup unit 200 according to the present embodiment adjusts the light intensity of a center portion of the spatial-light-intensity modulation element 20 corresponding to the S-polarized light portion in an integrated manner. It means that the spatial light-modulator drive-controlling unit 270 controls the center portion of the spatial-light-intensity modulation element 20 in such a manner that its light transmittance decreases at the timing of increase of the laser power thereby adjusting the laser power to the minimum value at which the servo control requires.

In the page-data recording or the reproduction waiting state, the spatial light-modulator drive-controlling unit 270 sets the light transmittance of the spatial-light-intensity modulation element 20 to the minimum value (substantially 0) to suppress unwanted influence on the recording layer of the optical information recording medium.

According to the present embodiment, in recording data on the RAM data-layer, recording actions of users are restricted by various codes. The comparison of the key unique-code with the access-restriction code recorded on the ROM data-layer is assumed to have been performed. If the clock 350 is used in addition, reliability of information on the RAM data-layer can be improved.

Specifically, it is possible to determine whether a recording action is allowable by comparing the key unique-code recorded on the IC card 340 and information acquired from the clock 350, for example, a recording date-and-time with an access-restriction code (the access-restriction code including a date-and-time code for permitting recording). It is preferable to use a wave clock, which is hardly subject to falsification from outside, as the clock 350.

Subsequently, a reproducing process performed by the optical information recording/reproducing apparatus of reproducing data from the RAM data-layer is explained. Assuming that the comparison of the key unique-code of the IC card 340 with the user identifier 1 formed with optical-phase pits on the lead-in area as the ROM data layer has finished in the following explanation. In a case of reproducing only, the comparison by using the clock 350 is not performed.

Upon receiving a command of specifying a file to be accessed from the host computer 400, the controller 300 starts accessing to the optical information recording medium 50. When the controller 300 starts an access operation, the controller 300 sends a command to the objective-lens/optical-head position controlling unit 220 to operate the optical pickup unit 200 and its objective lens. The controller 300 then accesses to an address on the ROM data-layer corresponding to a RAM area on which the target information to be reproduced is recorded.

In the process, the objective-lens/optical-head position controlling unit 220 controls a focus position and a track position, and the optical pickup unit 200 sends the address information and information on the access-restriction code to the ROM-information data splitting unit 230.

The ROM-information data splitting unit 230 splits data into the address information and the information on the access-restriction data, and sends the address information to the address-information detecting unit 250 and the information on the access-restriction data to the access-restriction code-data detecting unit 260.

The address-information detecting unit 250 detects an address on which the laser beam has reached based on the address information, and sends the detected address to the controller 300. The controller 300 determines whether the address detected by the address-information detecting unit 250 is correct, that is, whether the light beam that emits from the optical pickup unit 200 converges on a proper position on the optical information recording medium 50. When the address is not correct, the controller 300 sends a command to the objective-lens/optical-head position controlling unit 220 to correct a position of the objective lens.

The access-restriction code-data detecting unit 260 detects an access-restriction code recorded on the ROM data-layer. The detected access-restriction code contains the user identifier 1 and a user identifier 2. In reproducing information recorded on the RAM data-layer, the user identifier 1 is compared by the comparing unit 320 with the key unique-code of the IC card 340 (the key unique-code corresponding to the user identifier 1).

When the user identifier 1 agrees with the corresponding key unique-code, the controller 300 permits the host computer 400 to only retrieve information (file) that is recorded on the RAM data-layer.

Whether the host computer is permitted to access to a file recorded on the PAM data-layer is determined based on the user identifier 2. It means that the comparing unit 320 compares the user identifier 2 with a key unique-code of the IC card 340 (key unique-code corresponding to the user identifier 2). When both codes agree to each other, access from the host computer 400 to the file is permitted. The user identifier 2 is recorded on a rewritable area in the ROM data-layer, and is recorded, in correspondence with the information recorded on the RAM data-layer, on a position on the Rom data-layer that is located in a depth direction of the RAM information layer.

After the comparison of the user identifier 2 performed by the comparing unit 320, the comparing unit 320 sends an access-permission signal to the controller 300. The controller 300 instructs the objective-lens/optical-head position controlling unit 220 to trace a group of page data that forms a target file to be read.

The controller 300 sends a command to the spatial light-modulator drive-controlling unit 270 to output an reference light adjusted at the reproduction level. The laser-power monitoring/controlling unit 210 monitors the laser power of the reference light emitting from the optical pickup unit 200. The RAM data-layer data detecting unit 280 sequentially detects information recorded on the RAM data-layer by a unit of page data.

The controller 300 causes the RAM data-layer data detecting unit 280 to sequentially send the page data forming the target file to the controller 300. After decoding the page data, the controller 300 sends the decoded data to the host computer 400, and the host computer 400 displays the file on a display thereof.

In recording data on the RAM data-layer, the comparing unit 320 compares the access-restriction codes recorded on the ROM data-layer (for example, the user identifier and the user identifier 2) with the key unique-code of the IC card 340. When both codes agree to each other, recording of information on the RAM data-layer is permitted. It means that in recording of information on the RAM data-layer, after the comparison of the access-restriction code recorded on the ROM area layer corresponding to an area on which the information is recorded, actual recording starts from a header address as a recording start position.

The optical information recording/reproducing apparatus according to the present embodiment modulates, in recording of information on the RAM data-layer, it is not that the recording signal light emitting from each light source is modulated but that the recording signal light of each segment is adjusted by using the spatial light modulation element. Moreover, a portion corresponding to the servo control beam, which is components of the S-polarized light, is not divided into segments but integrally forms a single circle. Therefore, it is possible to detect data recorded on the ROM data-layer at any time in a similar manner detecting data from a normal DVD or CD. In addition, access-restriction codes such as the user identifiers 1 and 2 and a date can be compared and updated during recording of data on the RAM data-layer.

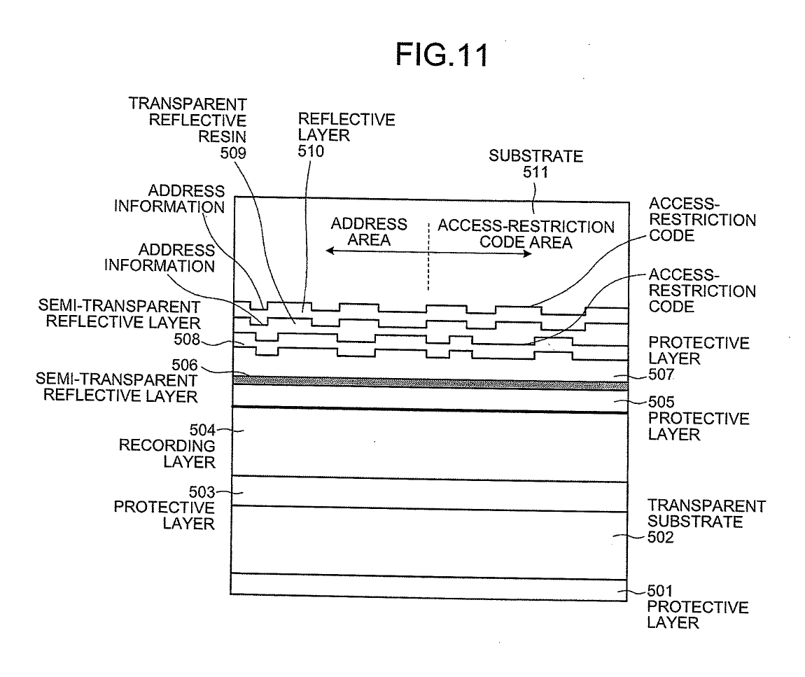

Given below is an explanation of structure of the optical pickup unit 200. FIG. 9 is an exemplary functional block diagram for explaining structure of the optical pickup unit 200. As shown in the figure, the optical pickup unit 200 includes a short-wavelength laser 40, a collimator lens 41, a ½-wavelength plate 42, the spatial-light-intensity modulation element 20, the optical-phase correction element 21, a polarization conversion element 43, a conjugate focus conversion lens 44, a half mirror cube 45, a polarization beam splitter 46, an objective lens 47, a polarizer 48, a convergent lens 49, a pinhole 51, a magnifying lens 52, a CMOS sensor 53, a detection lens 54, and a photo-detector 55.

The short-wavelength laser 40 emits a light beam, the light intensity of which is adjusted able to record or reproduce information. Adjustment of the light intensity is performed by the laser-power monitoring/controlling unit 210 under control of the controller 300.

In this optical system, when a light beam is emitted from the short-wavelength laser 40, the light beam is transmitted through the collimator lens 41 and converted into a light beam of P-polarized light by the half-wave plate 152. The light beam of the P-polarized light is made incident on the spatial-light-intensity modulation element 20 and the optical-phase correction element 21 and converted into recording signal light and reference light of the P-polarized light by the spatial-light-intensity modulation element 20 and the optical-phase correction element 21.

The polarization conversion element 43 is, for example, a ½-wavelength plate or a rotary plate and changes the direction of the polarization of the light beam to an orthogonal direction before or after the light beam passes through the polarization conversion element 43.

A polarization state of a light beam passed through a section around the polarization conversion element 43 remains in the P-polarized light and a polarization state of a light beam transmitted through the section of the polarization conversion element 43 is converted into the S-polarized light. The light beam of the S-polarized light is used as a light beam for servo control. Because a polarization direction of the light beam is orthogonal to the light beam of the P-polarized light that forms a transmission interference pattern, there is no mutual action.

The light beam of the P-polarized light is transmitted through the half mirror cube 45, the polarization beam splitter 46, and the objective lens 47 and made incident on the optical information recording medium 50 and forms an interference pattern to thereby record information on the optical information recording medium 50. Although in the polarization beam splitter 46, a P-polarized light transmittance is set to 100%, an S-polarized light transmittance to 50%, and a P-polarized reflectance factor to 50%, those values are not limited to the above values.

When the information recorded on the optical information recording medium 50 is reproduced, the optical information recording medium 50 is irradiated with the light beam of the P-polarized light as reference light. The light beam reflected by the optical information recording medium 50 is made incident on the CMOS sensor 53 through the objective lens 47, the polarization beam splitter 46, the half mirror cube 45, the polarizer 48, the convergent lens 49, the pinhole 51, and the magnifying lens 52. Thereafter, the light beam made incident on the CMOS sensor 53 is converted into an electric signal and subjected to amplification processing and decode processing, whereby the information stored on the optical information recording medium 50 is reproduced.

On the other hand, the light beam of the S-polarized light is converted into convergent light or divergent light by being transmitted through the conjugate focus conversion lens 44. The conjugate focus conversion lens 44 is explained in detail later.

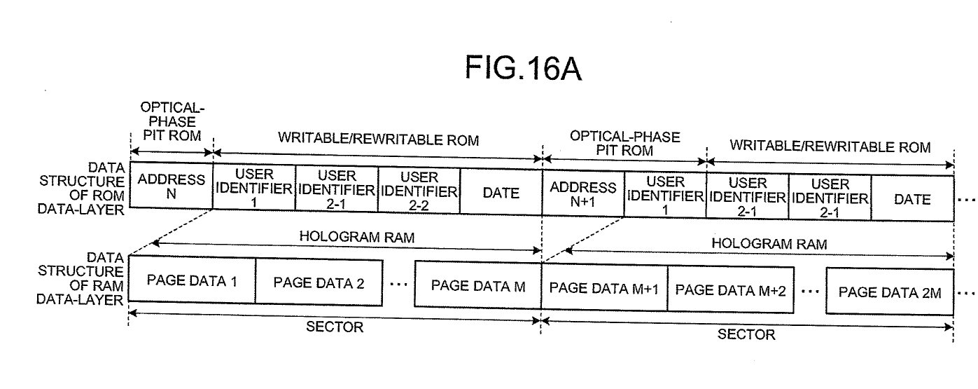

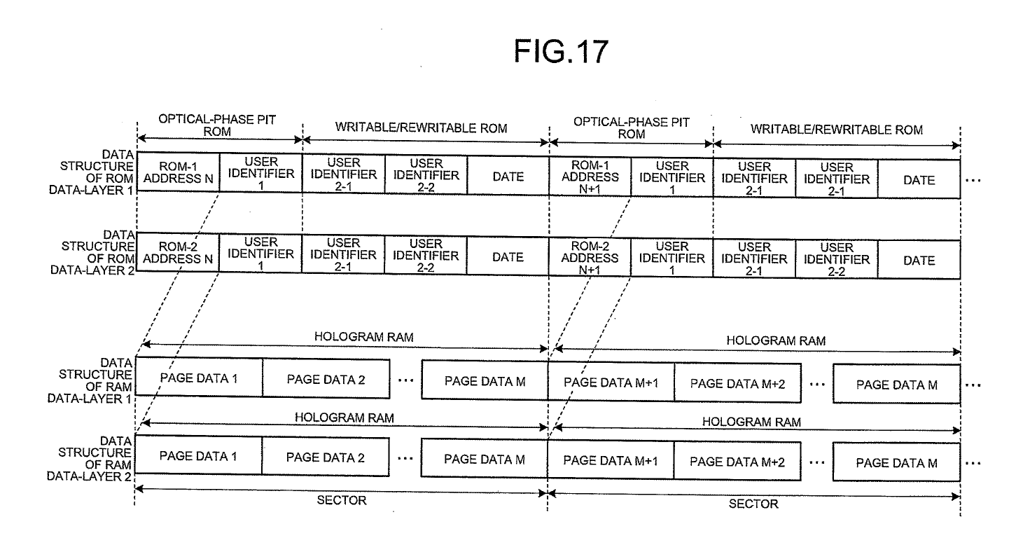

The light beam of the S-polarized light is transmitted through the half mirror cube 45 and the polarization beam splitter 46 and converges, according to the function of the objective lens 47, in a position on the optical information recording medium 50 different from the focus position of the light beam of the P-polarized light shown in FIG. 14 or 17.

After that, the S-polarized light beam is reflected by a reflective layer of the optical information recording medium 50 and passes through the objective lens 47, the polarization beam splitter 46, and the detection lens 54. The S-polarized light beam is converted into an electric signal by the photo-detector 55 that detects information on servo information including address information, a track error, and a focus error-signal and access-restriction codes concerning a rewritable area. Detailed description about the access-restriction code is explained later.

The signal obtained by the photo-detector 55 is transmitted to a controller that performs servo control of the objective lens 47. The control of a position of the objective lens 47 is performed based on information of the signal. The light beam can be caused to converge in a predetermined area of the optical information recording medium 50 by such control.

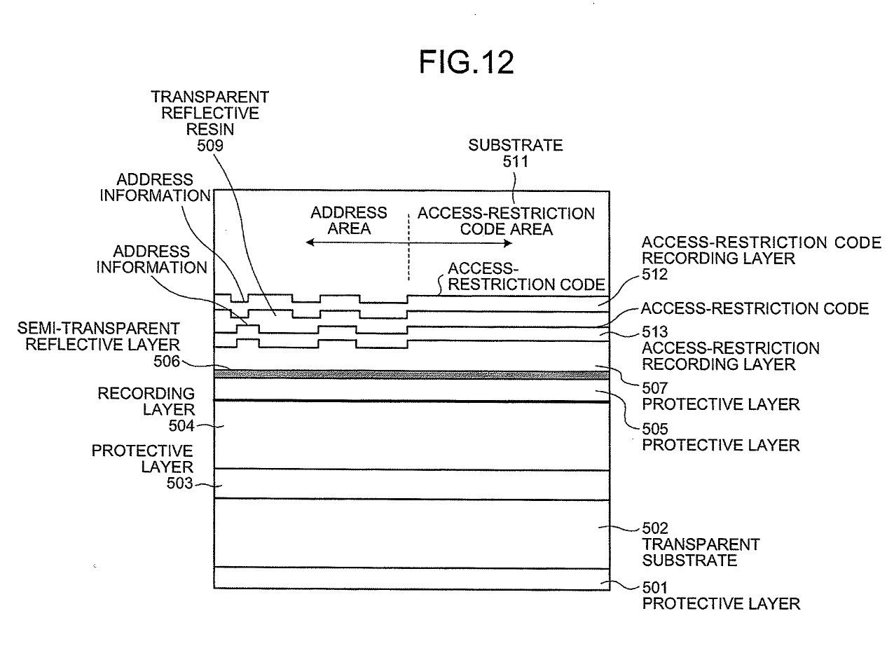

Given below is an explanation of structure of the conjugate focus conversion lens 44 shown in FIG. 9. FIG. 10 is a diagram of the structure of the conjugate focus conversion lens 44 shown in FIG. 9. As shown in the figure, the conjugate focus conversion lens 44 includes a plurality of conjugate focus conversion lenses, i.e., in the case of FIG. 10, a first conjugate focus conversion lens 60 and a second conjugate focus conversion lens 61.

In the case of FIG. 10, the first conjugate focus conversion lens 60 and the second conjugate focus conversion lens 61 are embedded in a transparent substrate 63 by integral molding to create the conjugate focus conversion lens 44.

by using the conjugate focus conversion lens 44, it is possible to change a position of a conjugate focus at three stages including a section of the transparent substrate 63 where the first conjugate focus conversion lens 60 and the second conjugate focus conversion lens 61 are not provided.

Specifically, by moving the conjugate focus conversion lens 44 to the left and right with a push-pull mechanism 62 employing an electromagnetic plunger, the section of the transparent substrate 63, the first conjugate focus conversion lens 60, or the second conjugate focus conversion lens 61 is arranged on an optical path on which the light beam of the S-polarized light passes.

The widths of the section of the transparent substrate 63 where the first conjugate focus conversion lens 60 and the second conjugate focus conversion lens 61 are not provided, the first conjugate focus conversion lens 60, a section of the transparent substrate 63 around the first conjugate focus conversion lens 60, and the second conjugate focus conversion lens 61 and a section of the transparent substrate 63 around the second conjugate focus conversion lens 61 are set to be equal to or larger than an light beam width of the collimator lens 41 shown in FIG. 9.

The objective lens 47 moves by using the servo mechanism in association with movement of the conjugate focus conversion lens 44 so that the S-polarized light beam converges on a position on the optical information recording medium 50 on which the address information and the access-restriction code is recorded, and the P-polarized light beam forms three patterns of transmission interference patterns in a depth direction of the recording layer of the optical information recording medium 50.

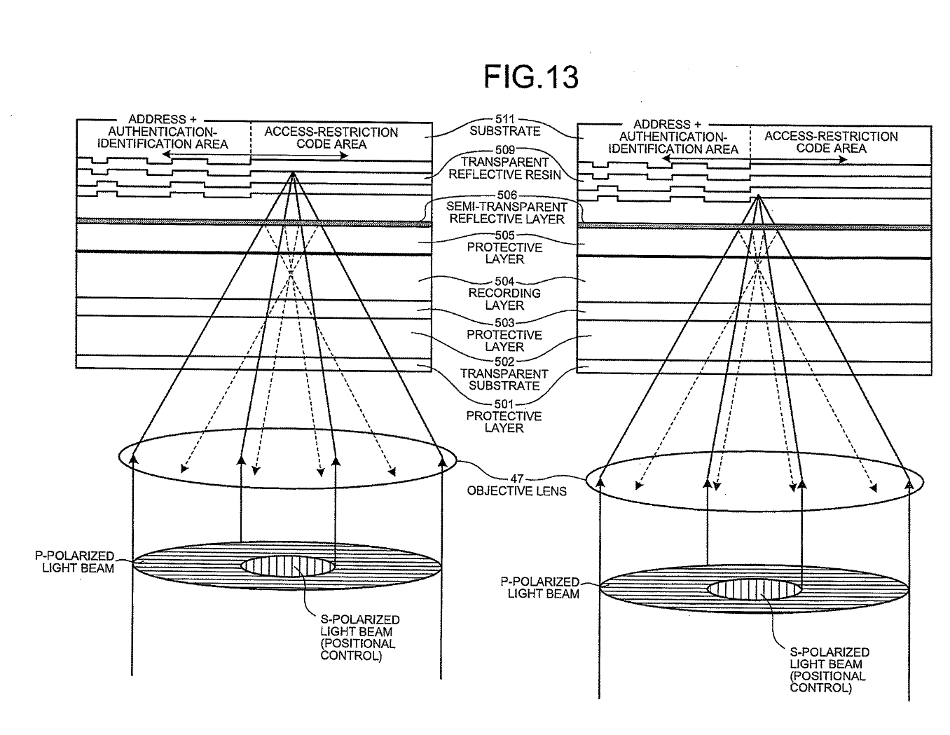

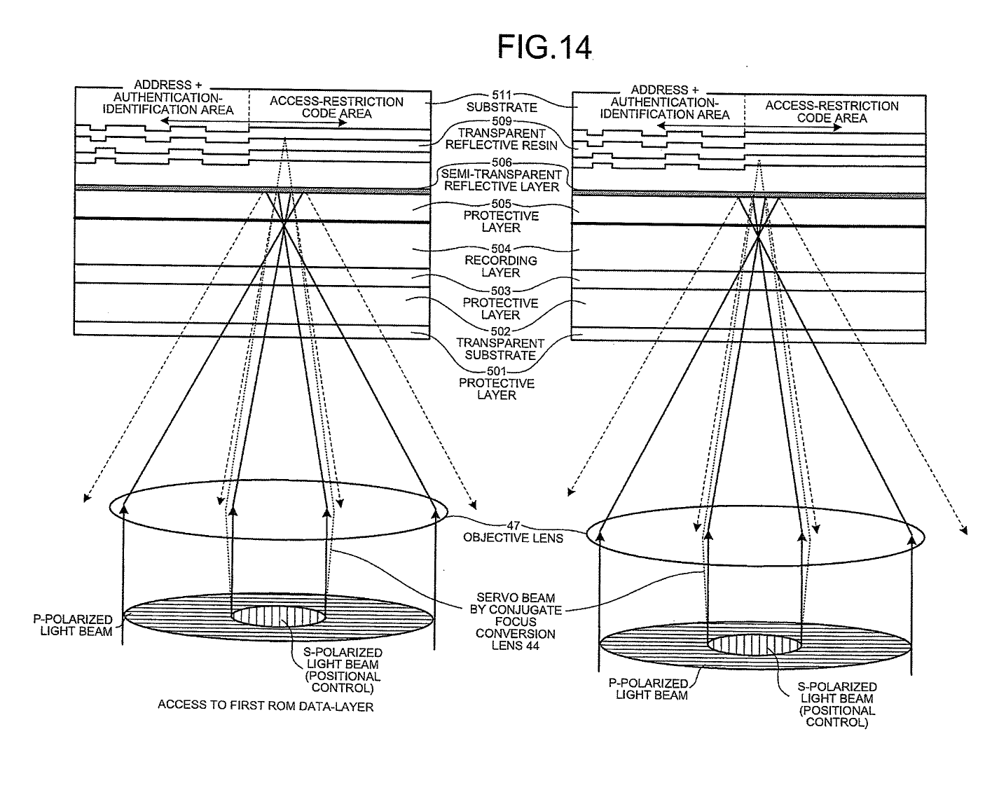

Structure of the optical information recording medium according to the present embodiment is explained. FIG. 11 is a diagram for explaining structure of the optical information recording medium according to the present embodiment (on which address information and access-restriction code are recorded in its initial state as non-rewritable optical-phase pits). FIG. 12 is a diagram for explaining structure of the optical information recording medium according to the present embodiment (of which the access-restriction code is recorded on a rewritable area).

As shown in FIG. 11, the optical information recording medium includes a protective layer 501, a transparent substrate 502, a protective layer 503, a recording layer 504, a protective layer 505, a semi-transparent reflective layer 506, a protective layer 507, a semi-transparent reflective layer 508, a transparent reflective resin 509, a reflective layer 510, and a substrate 511.

The recording layer 504 is made of a photo polymer that can be used as a hologram recording material. In the recording layer 504, the transmission interference patterns are formed on a three-dimensional area including a conjugate-point position on which the emitted recording signal light and the emitted reference light converge. The recording layer 504 is entirely made of the homogeneous photopolymer.

The address information and the access-restriction code are recorded as optical-phase pits on the substrate 511 in its initial state. The address information and the access-restriction code are also recorded as optical-phase pits on the transparent reflective resin 509 by using photo-polymerization in its initial state.

The optical information recording medium shown in FIG. 12 includes the protective layer 501, the transparent substrate 502, the protective layer 503, the recording layer 504, the protective layer 505, the semi-transparent reflective layer 506, the protective layer 507, the transparent reflective resin 509, the reflective layer 510, the substrate 511, and access-restriction code recording layers 512 and 513.

The access-restriction code recording layers 512 and 513 is made of, for example, a phase-change recording material a pigment-based write-once material. The access-restriction code is formed on the access-restriction code recording layers 512 and 513.

The access-restriction code recording layers 512 and 513 has a function as the semi-transparent reflective layer so the semi-transparent reflective layer 506 has. It is allowable that there provided a light transmittance/reflectance-factor adjusting film made of a metal or a dielectric material between the access-restriction code recording layers 512 and another light transmittance/reflectance-factor adjusting film made of a metal or a dielectric material between the access-restriction code recording layers 512 and the substrate 511.

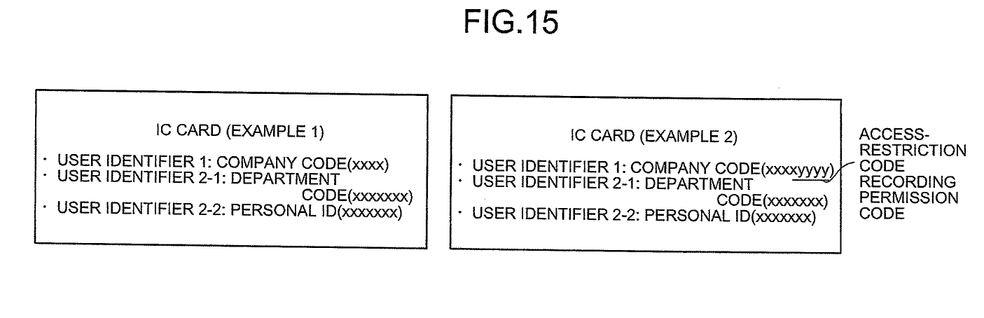

Given below is an explanation of a relation between the light beam (the P-polarized light beam and the S-polarized light beam) and units that form the optical information recording medium during recording or reproducing by using the optical pickup unit explained with reference to FIG. 9. FIG. 13 is an explanatory diagram (1) for explaining a relation between the light beam and units that form the optical information recording medium.

Given below is an explanation with reference to FIG. 13 of a relation between the light beam and units that form the optical information recording medium in a case that the transparent substrate 63 of the conjugate focus conversion lens 44 explained with reference to FIG. 10 is flat. The center portion of the light beam entering into the objective lens 47 is formed with components of the S-polarized light, which is to be the servo control beam. The ring portion surrounding the center portion is formed with components of the P-polarized light, which is to form the transmittance interference patterns.

The difference between the right-sided figure and the left-sided figure is whether the servo control beam accesses to either a ROM data-layer (layer containing information on addresses, authentication identifiers, and access-restriction codes) far away from the objective lens 47 or a ROM data-layer close to the objective lens 47.

As shown in examples in FIG. 13, because the transparent substrate 63 of the conjugate focus conversion lens 44 through which the light beam passes is flat, the light beam having the P-polarized components and the S-polarized components is under the influence of the objective lens 47 only. In this case, the P-polarized light beam that is to be the reference light and the recording signal light for forming the transmittance interference patterns is reflected by the semi-transparent reflective layer 506 at, for example, 70%. The reflected light beam is diffracted in the recording layer 504 where the diffracted reference light and the diffracted recording signal light are interfered with each other thereby forming a transmittance interference pattern in a three-dimensional area at a high optical-density, thus information is recorded.

The P-polarized light beam passed through the semi-transparent reflective layer 506 is reflected and diffracted by the optical-phase pits or the guide track under the influence of reflection function of the ROM data-layer. The reflectance factor of each layer of the ROM data-layer is 40% and lights entering from the both sides are reflected or pass through only once, 3.6% from a ROM data-layer that is laid on a side of the objective lens 47, and 3.24% from a ROM data-layer that is laid on a side far away from the objective lens 47. As a result, the optical density of the reflected components of P-polarized light beam in the recording layer 504 is extremely low, which suppresses an influence of the light beam reflected by each layer of the ROM data-layer over the recording layer 504 to an extremely low level.

In reproducing information recorded on the optical information recording medium by emitting the reference light to the transmittance interference patterns by using the same convergent lens 49 for convergence of the light reflected by the optical information recording medium, the pinhole 51 is required because the reflected lights have different convergence points. By using the pinhole 51, it is possible to shield high-order diffracted lights thereby removing noises during reproduction.

The light beam of S-polarized components converges on the ROM data-layer that stores address information formed with optical-phase pits, optical-phase pits, or an access-restriction code on a rewritable area, and is reflected by the ROM data-layer. About 50% of the reflected S-polarized light is reflected by the polarization beam splitter 46, and reaches the detection lens 54 and the photo-detector 55. The reached light beam is converted into address information and the access-restriction code.

FIG. 14 is an explanatory diagram (2) for explaining a relation between the light beam and the units that form the optical information recording medium. Given below is an explanation with reference to FIG. 14 of a relation between the light beam and units that form the optical information recording medium in a case that the light beam penetrates a concave-lens portion of the conjugate focus conversion lens 44 explained with reference to FIG. 10.

The center portion of the light beam entering into the objective lens 47 is formed with components of the S-polarized light, which is to be the servo control beam. The ring portion surrounding the center portion is formed with components of the P-polarized light, which is to form the transmittance interference patterns.

The difference between the right-sided figure and the left-sided figure is whether the servo control beam accesses to either the ROM data-layer far away from the objective lens 47 or the ROM data-layer close to the objective lens 47.

As shown in examples in FIG. 14, because the light beam passes through the concave-lens portion of the conjugate focus conversion lens 44, a focal point of the S-polarized light beam is located different from a focal point of the objective lens 47, that is, the S-polarized light beam converges on a point farther than the focal point of the objective lens 47.

In this case, the P-polarized light beam that is to form the reference light and the recording signal light for use in recording a transmittance interference pattern is reflected and diffracted, before reaching the semi-transparent reflective layer 506, in the recording layer 504 thereby the transmittance interference pattern is recorded.

After recording, 70%, for example, of the light beam is reflected by the semi-transparent reflective layer 506. A light beam passed through the semi-transparent reflective layer 506 is reflected and diffracted by the optical-phase pits or the guide track under the reflection function of the ROM data-layer. As is explained above with reference to FIG. 13, the reflectance factor of each layer of the ROM data-layer is 40% and lights entering from the both sides are reflected or pass through only once, 3.6% from a ROM data-layer laid on a side of the objective lens 47, and 3.24% from a ROM data-layer laid on a side far away from the objective lens 47. As a result, the optical density of the reflected components of P-polarized light beam in the recording layer 504 is extremely low, which suppresses an influence of the light beam reflected by each layer of the ROM data-layer over the recording layer 504 to an extremely low level.

In reproducing information recorded on the optical information recording medium by emitting the reference light to the transmittance interference patterns by using the same convergent lens 49 for convergence of the light reflected by the optical information recording medium, the pinhole 51 is required because the reflected lights have different convergence points. By using the pinhole 51, it is possible to shield high-order diffracted lights thereby removing noises during reproduction.

The light beam of S-polarized components converges on the ROM data-layer that stores address information formed with optical-phase pits, optical-phase pits, or an access-restriction code on a rewritable area, and is reflected by the ROM data-layer. About 50% of the reflected S-polarized light is reflected by the polarization beam splitter 46, and reaches the detection lens 54 and the photo-detector 55. The reached light beam is converted into address information and the access-restriction code.

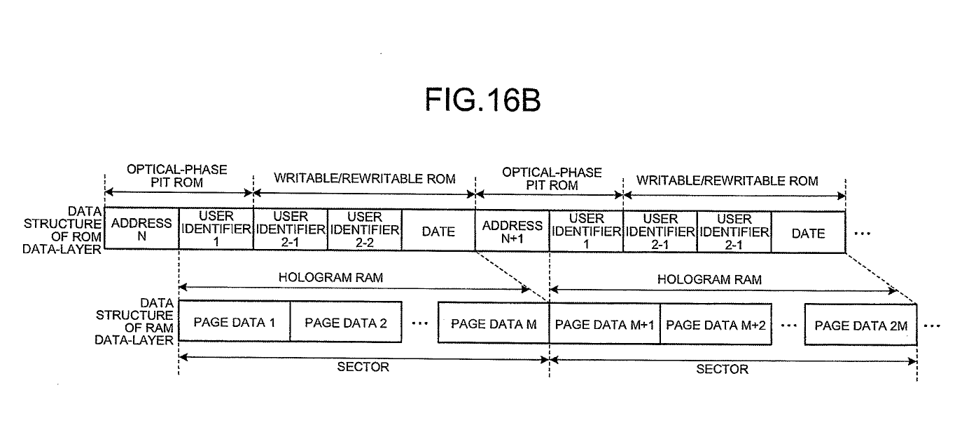

Given below is an explanation of the IC card 340 shown in FIG. 8. FIG. 15 is an exemplary diagram of the IC card 340 shown in FIG. 8. As shown in the figure, Example 1 includes a company code as the user identifier 1, a department code and a personal ID (Identification) as the user identifiers 2. Example 2 includes, in addition to the codes shown in Example 1, a restriction-code recording permission code for permitting recording of the access-restriction code. That is, the IC card of Example 1 cannot record the access-restriction code on a rewritable area. On the other hand, the IC card of Example 2 can record the access-restriction code on a rewritable area.

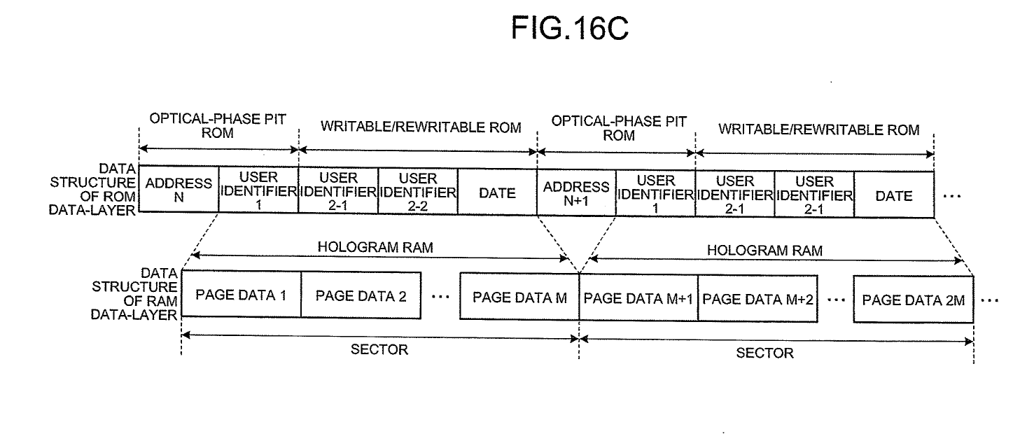

FIGS. 16A, 16B, and 16C are explanatory diagrams for explaining a relation between the access-restriction code recorded on the ROM data-layer and user data recorded on the PAM data-layer. As shown in these figures, the user identifier 1 is recorded as optical-phase pits following its address. The user identifier 1 can be recorded on a lead-in area of the optical information recording medium 50 in the ROM data-layer. If the user identifier 1 is recorded on a lead-in area, the comparison can be performed at lead-in when the optical information recording medium 50 is inserted into the optical information recording/reproducing apparatus, thus the comparison of comparing the user identifier 1 following its address can be skipped.

The user identifier 2 and the date code are recorded on a rewritable area. The order of the user identifier 2 and the date code is not limited to those shown in FIGS. 16A, 16B, and 16C.

Although the page data for each page looks separate, because the page data is recorded by using shift multiplexing, the page data for each page can be overlapped with each other depending on its multiplicity. As shown in the figures, a recording sector of the PAM data-layer corresponds to a portion starting from a code start position of the user identifier 1 recorded on the ROM data-layer and ending at an end position of the date code.

Because the conventional laser beam disks, such as conventional DVDs, employs bit-by-bit for recording data by using reflectance-factor change, which is induced by a laser beam having a diameter of 1 μm or narrower close to the diffraction-limited value, in extremely small areas, the address area is useless from the viewpoint of a recording area.

However, the present embodiment uses a transmission interference pattern for recording data on the PAM data-layer. In hologram recording by using a transmission interference pattern, a beam that forms the transmission interference pattern to be recorded on the RAM data-layer is about 100 μm that is extremely wider than the beam close to the diffraction-limited value.

As a result, a start position of a transmission interference pattern recorded on the RAM data-layer substantially agrees with an address start position in the ROM data-layer even when data is recorded from the address-area end position. It can be said that there is no useless area with respect to recording data on the ROM data-layer. In other words, a physical position of each sector of the ROM data-layer substantially agrees with a physical position of a corresponding virtual sector of the RAM data-layer with respect to the vertical direction.

As shown in FIG. 16B, it is possible to record data in such a manner that an end position of a RAM data-layer section corresponding to the address area N substantially agrees with an end position of an address area N+1. As shown in FIG. 16C, it is possible to record data in such another manner that both a start position of a RAM data-layer record-section corresponding to the address area N+1 and an end position of a RAM data-layer record section corresponding to the address area N, which is immediately before the address area N+1, are positioned in the address area N+1. Timing pits for recording information on the RAM data-layer or reproducing information from the RAM data-layer are formed on the ROM data-layer as optical-phase pits or wobble in its initial state.

The optical information recording medium 50 can includes a plurality of ROM data-layers and a plurality of RAM data-layers lying in the depth direction. FIG. 17 is an explanatory diagram for explaining correspondence relation between the ROM data-layers and the RAM data-layers in which the ROM data-layers lie in the depth direction of the optical information recording medium. An address on the ROM data-layer contains a layer number that is used for a servo control of selecting a ROM data-layer.

It is possible to add functions of the polarizing plate or the like to the protective layers forming the optical information recording medium as shown in FIG. 11 or 12. Although the embodiments are described under an assumption that information is recorded on the optical information recording medium according to the present invention in a circumferential direction by causing the optical information recording medium to rotate, it is difficult to add the functions of the polarizing plate to a rotating medium. An optical information recording medium in a form of a card (card-type optical information recording medium) is described below as an example. Of course, if there is a polarizing plate having a polarization axis orthogonal to the circumferential direction, it is possible to add the functions of the polarizing plate to a rotating medium.

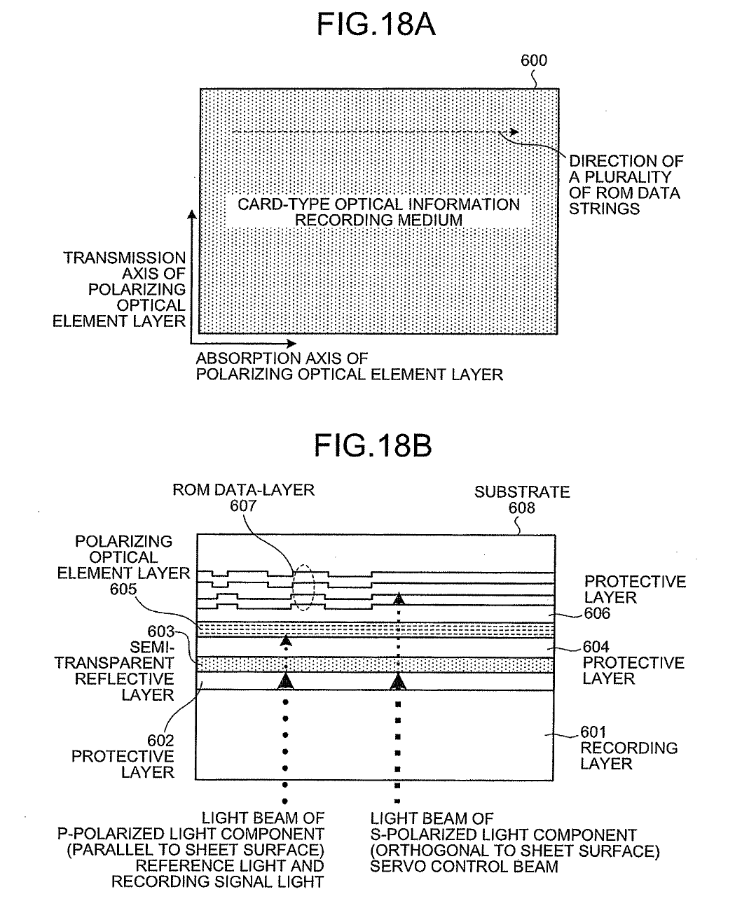

FIGS. 18A and 18B are diagrams for explaining the structure of the card-type optical information recording medium. As shown in the figure, a card-type optical information recording medium 600 includes a recording layer 601, a protective layer 602, a semi-transparent reflective layer 603, a protective layer 604, a protective layer 606, a ROM data-layer 607, and a substrate 608.

As shown in the figure, the servo control beam emitted to the card-type optical information recording medium 600 has the S-polarized light component only. The card-type optical information recording medium 600 is exposed with the light beam of the P-polarized light component containing the reference light and the recording signal light during recording of information, and is exposed with the light beam of the P-polarized light component containing the reference light only during reproducing of information. It is assumed that an optical information recording/reproducing apparatus that records or reproduces information on or from the card-type optical information recording medium 600 is similar to the optical information recording/reproducing apparatus as shown in FIG. 8.

The basic structure of the card-type optical information recording medium is similar to the optical information recording medium as shown in FIG. 11 or 12. That is, the card-type optical information recording medium includes the ROM data-layer and the RAM data-layer. The access restriction codes are recorded on the ROM data-layer by using optical-phase pits in the initial state. The ROM data-layer has the rewritable area as shown in FIG. 11 or 12.

The card-type optical information recording medium shown in FIG. 18B includes a polarizing optical element layer 605 though the optical information recording medium shown in FIG. 11 or 12 does not. The polarizing optical element layer 605 controls transmittance or reflectance of a light beam of the P-polarized light component or the S-polarized light component by using its transmission or absorption effect.

After passed through the protective layer 602 and the semi-transparent reflective layer 603, the reference light and the recording signal light, which are the P-polarized light component, further passes through the protective layer 604, and then are absorbed in, not reflected by or transmitting through, the polarizing optical element layer 605 in which an absorption axis is arranges in such a direction that can block the P-polarized light component.

Therefore, the reference light and/or the recording signal light, which are the P-polarized light component, cannot reach on the ROM data-layer 607. If a transmission interference pattern is formed in the recording layer 601, the reference light and/or the recording signal light does not exerts any adverse effects during recording or reproducing of information onto or from the recording layer 601 because the reference light and/or the recording signal light cannot reach on the ROM data-layer 607. Because the reference light and/or the recording signal light do not reach on the ROM data-layer 607, a diffraction phenomenon caused by the optical-phase pits on the ROM data-layer 607, the guide tracks on the rewritable area, intensity modulation effects after recording, and optical-phase changes.

On the other hand, because the polarization direction of the servo control beam, which is the S-polarized light component, is orthogonal to the polarization direction of the reference light and the recording signal light, which are the P-polarized light component, the servo control beam can penetrate the polarizing optical element layer 605 so that it is possible to detect the servo signal and the access-restriction code from the ROM data-layer 607. It means that the polarizing optical element layer 605 arranged in the card-type optical information recording medium causes no problem.

Although the optical-phase pits or the guide tracks are formed on the substrate 608 in the same process as described with reference to the FIG. 11 or 12, a plurality of the optical-phase pits or the guide tracks, each of which having an independent structure, is arranged side-by-side stretching in a linear direction not in the circumferential direction.

If the optical pickup units 100 and 200 shown in FIG. 8 accesses to the card-type optical information recording medium 600, there generally provided a driving device that can drive the optical pickup unit 100, 200 and the card-type optical information recording medium 600 in a relative manner. The optical information recording/reproducing apparatus includes a driving system in which, at the same time the card-type optical information recording medium 600 moves in direction A in which data streams on the ROM data-layer of the card-type optical information recording medium 600 are stretching, the optical pickup unit 100 or 200 moves within a plane orthogonal to the direction A while the focus/track control can be performed by using the objective lens.

As described above, when the optical information recording/reproducing apparatus according to the present embodiment receives from the host computer 400 a request for accessing to the optical information recording medium 50, the optical pickup unit 100 reads the access-restriction code recorded on the ROM data-layer, and the comparing unit 320 compares the read access-restriction code with the key unique-code recorded on the IC card 340 thereby determining whether accessing to the optical information recording medium 50 is allowable. As a result, rewriting or falsification of data by un-authorized third parties can be prevented.

Moreover, upon receiving from the host computer 400 a request for rewriting the access-restriction code recorded on the optical information recording medium 50, the optical information recording/reproducing apparatus according to the present embodiment compares the user identifier 1 recorded on the un-rewritable area for the access-restriction codes with the key unique-code (code corresponding to the user identifier 1) recorded on the IC card 340, determines whether rewriting of the user identifier 2 (and/or date information) recorded on the rewritable area for the access-restriction codes is allowable, and rewrites the user identifier 2. This makes it possible to save an ever-larger amount of time and costs for changing the access-restriction codes.

Furthermore, the optical information recording medium according to the present embodiment includes the RAM data-layer on which the user data is recorded, and the ROM data-layer on which the access restriction codes for restricting accessing to the user data recorded on the RAM data-layer are recorded. The ROM data-layer is spaced apart from the RAM data-layer in a predetermined distance. This makes it possible to effectively use the recording capacity without reducing an available recording capacity.

Moreover, the optical information recording medium according to the present embodiment records the access-restriction codes on the ROM data-area, records, out of the user identifiers 1 and 2 both contained in the access-restriction code, the user identifier 1 on the un-rewritable area, and records the user identifier 2 on the rewritable area so that the authorized administrator can rewrite the access-restriction code smoothly.

If the optical information recording/reproducing apparatus and the optical information recording medium according to the present invention are used, the controller 300 notifies the host computer 400 of only presence information on a RAM area in the RAM data-layer. Therefore, the host computer 400 cannot acquire the access-restriction code recorded on the ROM data-layer. It means that it is virtually impossible for an un-authorized third party to read an access-restriction code recorded on the ROM data-layer to falsify the access-restriction code by operating the OS (Operating System) in an illegal manner.

According to an aspect of the present invention, an optical information recording/reproducing apparatus emits a light beam to an optical information recording medium including a first recording layer on which information is recorded by using interference of light beams and a second recording layer on which information corresponding to the information recorded on the first recording layer is recorded, and reads both the information recorded on the first recording layer and the information recorded on the second recording layer at one time. This makes it possible to effectively access to the information recorded on the first recording layer and the information recorded on the second recording layer.

Moreover, according to another aspect of the present invention, restriction information containing information for restricting accessing to the information that is recorded on the first recording layer is recorded on the second recording layer. The optical information recording/reproducing apparatus determines whether writing to the first recording layer is allowable based on the restriction information, and writes information on the first recording layer based on a result of the determination. This makes it possible to prevent falsification of the information recorded on the first recording layer thereby enhancing reliability.

Furthermore, according to still another aspect of the present invention, the restriction information containing information for restricting access to the information that is recorded on the first recording layer is recorded on the second recording layer. The optical information recording/reproducing apparatus determines whether reading from the first recording layer is allowable based on the restriction information, thereby allowing enhancing reliability of the information recorded on the first recording layer.

Moreover, according to still another aspect of the present invention, because the optical information recording/reproducing apparatus determines whether second restriction information (recorded on a rewritable area) contained in the restriction information based on first restriction information (recorded on an un-rewritable area) contained in the restriction information, and rewrites the second restriction information based on a result of the determination, an authorized administrator can rewrite the restriction information smoothly.

Furthermore, according to still another aspect of the present invention, upon receiving a request for reading information from the optical information recording medium, the optical information recording/reproducing apparatus outputs only information concerning the first recording layer. This makes it possible to enhance reliability of the optical information recording/reproducing apparatus.

Moreover, according to still another aspect of the present invention, the optical information recording/reproducing apparatus acquires date-and-time information, determines whether writing of information to the first recording layer is allowable based on the acquired date-and-time information and the restriction information, and then writes the information to the first recording layer, thereby allowing enhancing the reliability of the information recorded on the first recording layer.

Furthermore, according to still another aspect of the present invention, the optical information recording/reproducing apparatus acquires date-and-time information, and determines whether reading from the first recording layer is allowable based on the acquired date-and-time information and the restriction information, thereby allowing enhancing the reliability of the information recorded on the first recording layer.

Moreover, according to still another aspect of the present invention, an optical information recording medium includes a first recording layer on which information is recorded and a second recording layer spaced apart from the first recording layer in a predetermined distance. There recorded on the second recording layer information that is corresponding to the information recorded on the first recording layer and is accessed together with the information recorded on the first recording layer. By using the optical information recording medium, recording or reproducing of a plurality of pieces of information associated with each other can be performed effectively.

Furthermore, according to still another aspect of the present invention, in the optical information recording medium, there recorded on the second recording layer restriction information containing information for restricting accessing to the information that is recorded on the first recording layer is recorded on the second recording layer. This makes it possible to restrict illegal accesses to the information recorded on the first recording layer.

Moreover, according to still another aspect of the present invention, in the optical information recording medium, information are recorded on the first recording layer in a form of hologram, which allows increasing of recording density.

Furthermore, according to still another aspect of the present invention, pieces of the information recorded on the first recording layer and pieces of the information recorded on the second recording layer correspond to each other in one-to-one relation in the optical information recording medium, so that it is possible to effectively restrict accessing to the information recoded on the first recording layer.

Moreover, according to still another aspect of the present invention, the optical information recording medium can include a plurality of first recording layers and a plurality of first recording layers, thereby allowing improving recording density.

Furthermore, according to still another aspect of the present invention, there recorded on the second recording layer address information indicative of address of the information recorded on the first recording layer in the optical information recording medium so that it is possible to effectively access to the information recorded on the first recording layer.

Moreover, according to still another aspect of the present invention, information corresponding to the address information recorded on the second recording layer is recorded on a recording area of the first recording layer that is to be accessed together with the address information so that idle operation on the first recording layer can be saved.

Furthermore, according to still another aspect of the present invention, the restriction information recorded on the second recording layer is recorded on an un-rewritable area in the optical information recording medium so that it is possible to enhance reliability of the information recorded on the first recording layer.

Moreover, according to still another aspect of the present invention, because first restriction information contained in the restriction information is recorded on an un-rewritable area and second restriction information contained in the restriction information is recorded on a rewritable area in the optical information recording medium, an authorized administrator can rewrite the restriction information smoothly.

Furthermore, according to still another aspect of the present invention, date-and-time information is additionally recorded on the second recording layer in the optical information recording medium, which allows enhancing reliability of the information recorded on the first recording layer.

Moreover, according to still another aspect of the present invention, the first recording layer is made of a homogeneous recording material in the optical information recording medium, which allows proper recording of information on the first recording layer.

Furthermore, according to still another aspect of the present invention, a polarizing optical element is provided between the first recording layer and the second recording layer in the optical information recording medium to block a light beam for recording information on the first recording layer. This makes it possible to effectively record recording on each recording layer.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An optical information recording/reproducing apparatus for recording or reproducing information on or from an optical information recording medium by emitting a light beam to the optical information recording medium, the optical information recording medium including a first recording layer on which information is recorded and a second recording layer on which information corresponding to the information recorded on the first recording layer is recorded, the optical information recording/reproducing apparatus comprising an acquiring unit that acquires the information recorded by using interference of light beams on the first recording layer and the information recorded on the second recording layer corresponding to the information recorded on the first recording layer at one time.

2. The optical information recording/reproducing apparatus according to claim 1, wherein
restriction information is recorded on the second recording layer, the restriction information containing information for restricting accessing to the information recorded on the first recording layer, and wherein
the optical information recording/reproducing apparatus further comprises:
a writing determining unit that determines whether writing of information onto the first recording layer is allowable based on the restriction information; and
a writing unit that writes, based on a result of determination performed by the writing determining unit, the information onto the first recording layer in such a manner that the information corresponds to the restriction information.

3. The optical information recording/reproducing apparatus according to claim 2, further comprising a reading determining unit that determines whether reading of the information recorded on the first recording layer corresponding to the restriction information is allowable based on the restriction information recorded on the second recording layer.

4. The optical information recording/reproducing apparatus according to claim 2, wherein
the restriction information includes first restriction information which is unrewritable and second restriction information which is rewritable, and wherein
the optical information recording/reproducing apparatus further comprises:
a rewriting determining unit that determines, upon receiving a request for rewriting the second restriction information recorded on the second recording layer, whether rewriting of the second restriction information is allowable based on the first restriction information; and
a restriction-information rewriting unit that rewrites the second restriction information based on a result of determination performed by the rewriting determining unit.

5. The optical information recording/reproducing apparatus according to claim 1, further comprising an outputting unit that outputs, upon receiving a request for reading information from the optical information recording medium, only information on the first recording layer.

6. The optical information recording/reproducing apparatus according to claim 2, further comprising a date-and-time information acquiring unit that acquires current date-and-time information, wherein
the restriction information additionally includes date-and-time information, and
the writing determining unit determines whether writing of information onto the first recording layer is allowable by further comparing the current date-and-time information acquired by the date-and-time information acquiring unit with the date-and-time information of the restriction information.

7. The optical information recording/reproducing apparatus according to claim 3, further comprising a date-and-time information acquiring unit that acquires current date-and-time information, wherein
the restriction information additionally includes date-and-time information, and
the reading determining unit determines whether reading of information from the first recording layer is allowable by comparing the date-and-time information acquired by the date-and-time information acquiring unit with the date-and-time information of the restriction information.

8. An optical information recording medium comprising:
a first recording layer on which information is recorded by using interference of light beams; and
a second recording layer on which information corresponding to the information recorded on the first recording layer is recorded, wherein the information recorded on the second recording layer is to be accessed together with the information recorded on the first recording layer, and the second recording layer is spaced apart from the first recording layer in a predetermined distance.

9. The optical information recording medium according to claim 8, wherein restriction information is recorded on the second recording layer, the restriction information containing information for restricting accessing to the information recorded on the first recording layer.

10. The optical information recording medium according to claim 8, wherein the information is recorded on the first recording layer in a form of hologram.

11. The optical information recording medium according to claim 9, wherein each piece of the information recorded on the first recording layer and each piece of the information recorded on the second recording layer correspond to each other in a one-to-one relation.

12. The optical information recording medium according to claim 8, wherein there are a plurality of the first recording layers and/or the second recording layers.

13. The optical information recording medium according to claim 9, wherein address information is additionally recorded on the second recording layer, the address information being for identifying a position of the information recorded on the first recording layer.

14. The optical information recording medium according to claim 13, wherein information corresponding to the address information is recorded on a recording area of the second recording layer, the recording area being accessed together with the address information recorded on the first recording layer.

15. The optical information recording medium according to claim 9, wherein the restriction information recorded on the second recording layer is recorded on an un-rewritable area.

16. The optical information recording medium according to claim 9, wherein the restriction information includes first restriction information and second restriction information, the first restriction information being recorded on an un-rewritable area of the second recording layer, and the second restriction information being recorded on a rewritable area of the second recording layer.

17. The optical information recording medium according to claim 8, wherein date information is additionally recorded on the second recording layer.

18. The optical information recording medium according to claim 8, wherein the first recording layer is made of a homogeneous recording material.

19. The optical information recording medium according to claim 8, further comprising a polarizing optical element layer between the first recording layer and the second recording layer, wherein the polarizing optical element layer blocks, out of light beams having a different polarization state and including a light beam that is to access to the first recording layer and a light beam that is to access to the second recording layer, the light beam that is to access to the second recording layer.
